(19) United States
(12) Patent Application Publication
(10) Pub. No.: US 2008/0142292 A1
(43) Pub. Date: Jun. 19, 2008

(54) Electrohydraulic Vehicle Steering System with a Linear Pressure Characteristics

(76) Inventors: Ronald Bayer, Mühlheim/Main (DE); Johann Jungbecker, Badenheim (DE); Steffen Linkenbach, Eschborn (DE); Norman Muth, Frankenberg (DE); Xiuxun Yin, Duisburg (DE)

Correspondence Address: CONTINENTAL TEVES, INC., ONE CONTINENTAL DRIVE, AUBURN HILLLS, MI, 48326-1581, US

(21) Appl. No.: 11/884,156

(22) PCT Filed: Feb. 15, 2006
(86) PCT No.: PCT/EP06/50943

§ 371 Date: Aug. 10, 2007

(30) Foreign Application Priority Data
Feb. 16, 2005 (DE) 10 2005 006 967.3
Feb. 13, 2006 (DE) 10 2006 722.3

(51) Int. Cl. B62D 5/08

(52) U.S. Cl. 180/441

(57) ABSTRACT

A vehicle steering system for motor vehicles includes a steering handle, which is connected to steerable vehicle wheels in terms of effect in order to predefine a driving direction, as well as a hydraulic working cylinder including two cylinder chambers. Further, a hydraulic pressure source is provided, which applies hydraulic pressure to a steering valve designed as a slide valve. The steering valve controls the magnitude of the hydraulic pressure that is conveyed to the cylinder chambers of the working cylinder, and a differential pressure determines the effective direction and the magnitude of the steering aid. The steering valve is a slide valve and includes a control assembly comprising a control sleeve and a control slide. The control sleeve has at least one control window, and the differential pressure in a non-linear relationship depends on the free cross-sectional surface of the control window, which is variable due to displacement of the control slide. The edge of the control window is so configured that the free cross-sectional surface of the control window changes in such a fashion that the magnitude of the differential pressure depends substantially linearly on the displacement of the control slide.

### BACKGROUND OF THE INVENTION

The present invention relates to an electrohydraulic vehicle steering system for motor vehicles.

In modern motor vehicles with low front-axle loads, which necessitate accordingly low control forces of the vehicle steering system, conventional hydraulic servo steering systems are replaced by electromechanical steering systems (EPAS: ‘electric power assisted steering’) at an increasing rate. In these electromechanical steering systems, the steering force assisting the driver is generated using an electric motor. The electromotive auxiliary drive allows the steering control to adapt automatically to the respective driving situation. More specifically, this implies that the steering performance in terms of the steering sensitivity and the degree of the steering aid force for the driver is completely different during a freeway drive than in city traffic, for example, where speeds are much lower and the steering angles are much greater than on a freeway. Furthermore, it is possible to realize external interventions by so-called driver assist functions such as a parking assistant or a tracking assistant, where the electromotive drive is driven by the respective driver assist systems.

The electromechanical steering system is characterized by an approximately linear transmission behavior of the current-controlled drive motor, that means, the motor current and the generated steering aid force exhibit a roughly proportional behavior. This renders it possible to achieve a very robust controller behavior of the steering aid.

In vehicles with higher front-axle loads, requiring major steering rack forces for the vehicle steering system, a correspondingly high setting capacity for the steering aid is necessary. With a standard voltage of the electrical wiring system of 12 volt, the current strengths then required for the electromotive auxiliary drive of an electromechanical steering system are so high that they can practically no more be handled in the motor vehicle.

From this results that it is better in vehicles with high front-axle loads to provide the auxiliary energy for the steering aid as hydraulic energy by means of a steering aid pump driven by the internal combustion engine of the vehicle. Hydraulic steering aid systems generate steering aid forces by means of a hydraulic steering aid pressure. The steering aid pressure is controlled by means of a slide valve. However, the magnitude of the steering aid pressure does not depend linearly on the adjusting travel of a control slide of the slide valve. This case also implies that the control shows non-linear characteristics. Such a behavior at least impairs the control of the steering aid.

Based on the above, an object of the invention involves providing a hydraulic vehicle steering system, which overcomes this drawback and includes an adaptable steering characteristics.

### SUMMARY OF THE INVENTION

This object is achieved by a vehicle steering system according to the invention for use in motor vehicles, which comprises a steering handle, which is operable by the driver and is connected to steerable vehicle wheels in terms of effect in order to predefine a driving direction, as well as a hydraulic working cylinder including two cylinder chambers. Further, a hydraulic pressure source is provided, which applies hydraulic pressure to a steering valve designed as a slide valve. The steering valve controls the magnitude of the hydraulic pressure that is conveyed to the cylinder chambers of the working cylinder, and a differential pressure determines the effective direction and the magnitude of the steering aid. The steering valve is a slide valve and includes a control assembly comprising a control sleeve and a control slide. The control sleeve has at least one control window, and the differential pressure in a non-linear relationship depends on the free cross-sectional surface of the control window, which is variable due to displacement of the control slide. The edge of the control window is configured in such a way that the free cross-sectional surface of the control window changes in such a fashion that the magnitude of the differential pressure depends substantially linearly on the displacement of the control slide.

Several control windows are provided according to an improvement of the invention.

In a suitable embodiment of the vehicle steering system of the invention, the adjustment of the control slide is a translational displacement. Favorably, a drive for adjustment of the control slide can be provided.

The drive is an electromagnetic or an electromotive actuator in a suitable embodiment. The electromotive actuator can be coupled to a gear in terms of driving, which gear converts a rotation into a translational movement.

The drawings illustrate an embodiment of a vehicle steering system of the invention. Like or corresponding parts have been designated by identical reference numerals.

### BRIEF DESCRIPTION OF THE DRAWINGS

In the accompanying drawings:

FIG. 1 is a schematic view of the vehicle steering system of the invention;

FIG. 2a is a schematic view of a linear slide valve with external control;

FIG. 2b shows a basic wiring diagram of a hydraulic full bridge and an equation related to restrictors that determines the pressure behavior;

FIG. 3a shows a round control window in a control sleeve;

FIG. 3b shows the boosting pressure as a function of the displacement travel of the control slide in the event of a control window with a circular cross-sectional surface and the linearized variation of the boosting pressure;

FIG. 4a shows the change in surface of a control window designed according to the invention as a function of the displacement travel compared to a linear change in surface of the control window;

FIG. 4b shows the shape of a control window in the slide valve of the vehicle steering system of the invention.

### DETAILED DESCRIPTION OF THE DRAWINGS

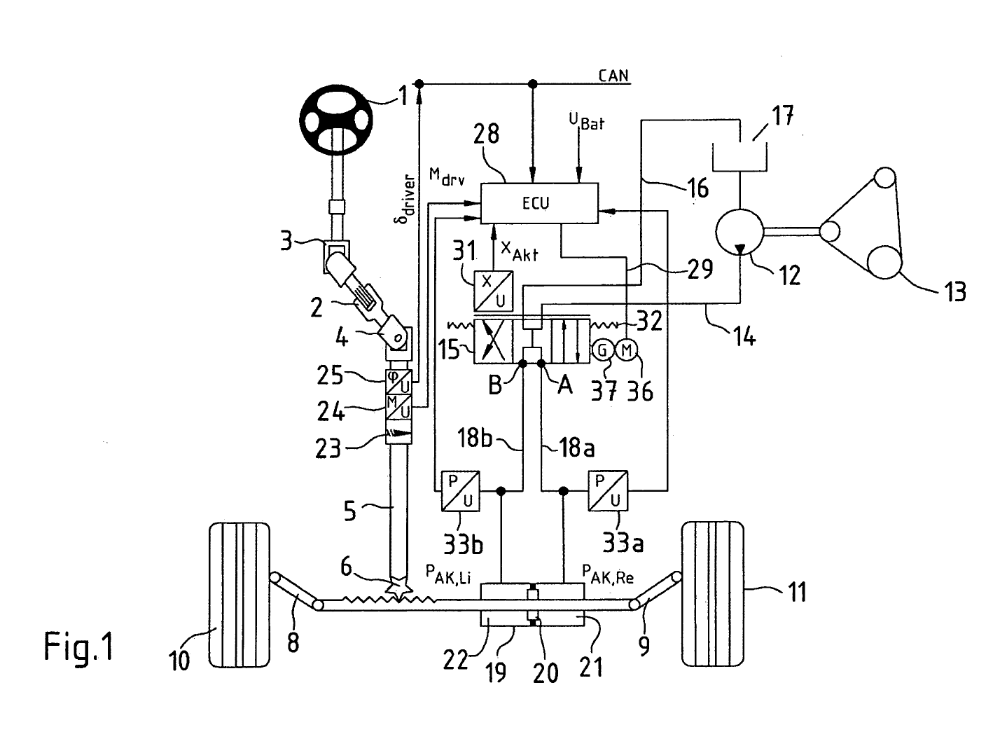

FIG. 1 shows a basic diagram of an embodiment of the vehicle steering system of the invention. Beside the schematic design of the vehicle steering system relating to apparatus, sensor information is shown in FIG. 1 as well, being required to realize the functions of the vehicle steering system of the invention.

The steering system illustrated in FIG. 1 comprises a steering wheel 1 and a steering column 2, which is connected to the steering wheel 1 and has two universal joints 3, 4. The steering column 2 is connected to a steering wheel shaft 5 or forms part of the steering wheel shaft 5. The steering wheel shaft 5 drives a steering gear 6, converting the rotation of the steering wheel shaft 5 into a translational motion of a steering rod 7. In FIG. 1, the steering rod 7 is configured as toothed rack 7 that operates the tie rods 8, 9 arranged at the steering rod. The actuation of the tie rods 8, 9 causes wheels 10, 11 to deviate in order to steer the direction of travel of the vehicle.

In the rack-and-pinion steering shown herein, hydraulic assistance is realized by means of a hydraulic pump 12 driven by the drive motor of the vehicle. Pump 12 is driven by way of a belt drive 13 in the illustrated embodiment. Of course, all other appropriate driving means known from the state of the art are also feasible in order to realize the invention at issue.

Hydraulic pump 12 produces pressure in a hydraulic medium or a hydraulic fluid being fed through a conduit 14 to a steering valve 15. The pressure fluid can flow back into a supply reservoir 17 by way of a return conduit 16. The steering valve 15 connects to a hydraulic cylinder 19 via two hydraulic conduits 18a, 18b.

A piston 20 subdivides the hydraulic cylinder 19 into two cylinder chambers 21, 22. Piston 20 is immovably seated on the steering rod 7 so that the piston 20 can exert a force directly on the steering rod 7 when different pressures are applied to the two cylinder chambers 21, 22.

A torsion rod 23, a torque sensor 24, and an angle sensor 25 are arranged between the second universal joint 4 and the steering gear 6.

The angle sensor 25 measures the angle of rotation predefined by a driver using the steering wheel 1 and outputs an output signal δ_{driver} that is representative of this angle of rotation. The output signal δ_{driver} is transmitted to a central control unit (ECU) 28.

The torque sensor 24 measures the torque exerted by the driver and sends an output signal M_{drv} representative of the torque to the control unit 28.

A control conduit 29 leads from the control unit 28 to the steering valve 15 in order to determine the direction and the magnitude of the steering aid by means of a control slide, meaning which one of the two cylinder chambers 21, 22 is acted upon by hydraulic fluid. The position of the slide in the steering valve 15 is measured by means of a distance sensor 31, whose output signal is fed back to the control unit 28 in order to close a control circuit.

In the event of system failure, the steering valve 15 establishes a hydraulic short-circuit between the two cylinder chambers 21, 22 of the working cylinder 19. The steering valve 15 is configured in such a way that it is biased by a mechanical spring 32 to adopt the short-circuit position illustrated in FIG. 1. This fact safeguards that the vehicle remains steerable due to the mechanical coupling between the steering wheel 1 and the steering rod 7. The hydraulic short-circuit between the cylinder chambers 21, 22 ensures that the piston 20 and, thus, the steering rod is displaceable.

One pressure sensor 33a, 33b each is connected in terms of flow to the two cylinder chambers 21, 22 in order to measure the respective working pressure in the cylinder chambers, which is also referred to as actuator pressure. The respective pressure in the left-hand or right-hand cylinder chamber is designated by p_{AK,LI} or p_{AK,RE} in FIG. 1. The output signals of the pressure sensors 33a, 33b are sent as inlet signals to the control unit 28 via signal conduits 34a, 34b.

The control unit 28 receives another input signal from a vehicle bus CAN. This signal can e.g. originate from a driver assist system.

Finally, the electronic control unit 28 also receives a signal U_{bat}, representative of the battery voltage, in order to be able to trigger a failure report in case of need when the battery voltage U_{bat} drops below a defined threshold value and proper functioning of the vehicle steering system is no longer safeguarded. A failure report causes the steering valve 15 to provide a hydraulic short-circuit between the cylinder chambers 21, 22, deactivating the hydraulic steering aid.

The steering valve 15 is a hydraulic full bridge with ‘open center’, what implies that oil flows through the steering valve in the straight-ahead position of the vehicle steering system. The steering valve 15 is driven by way of a servo motor 36 and a rotation-translation gear 37 in order to convert the rotation of the servo motor 36 into a translational motion for controlling the steering valve 15. In an alternative embodiment of the invention, the steering valve 15 is driven by way of an electromagnetic drive (not shown).

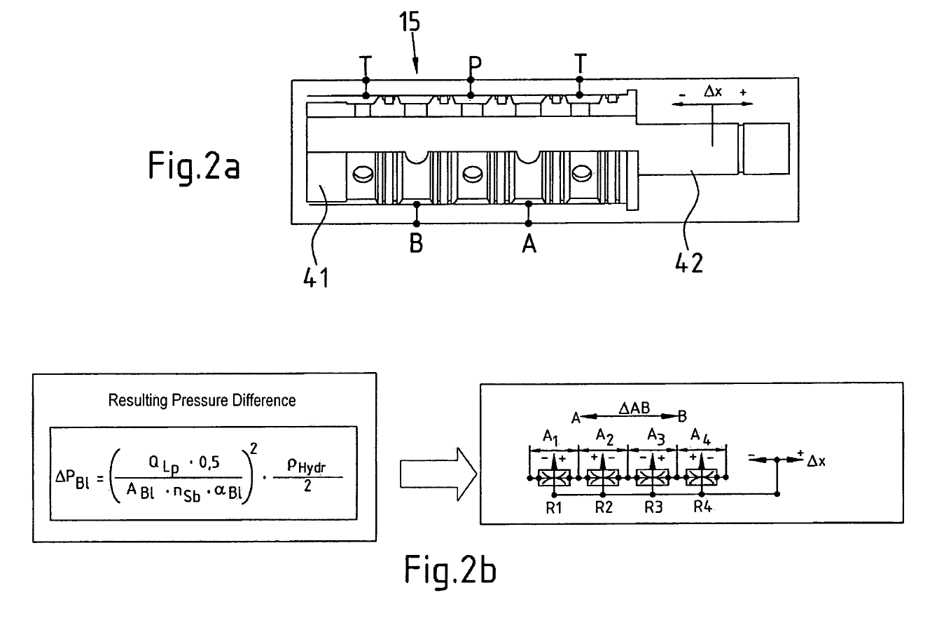

The steering valve 15 is shown in more detail in FIG. 2a in a perspective and partly cross-sectional view. The steering valve 15 includes a control sleeve 41, in which a control slide 42 is translationally displaceable. The control sleeve 41 comprises two connections T constituting a non-pressurized flow connection to the reservoir 17 with hydraulic fluid. Furthermore, the control sleeve 41 has a connection P, at which the pressure conduit 14 from the pump 12 is connected. Finally, two connections A and B are provided to establish a connection to the right-hand and left-hand cylinder chamber 21, 22 in FIG. 1. The control sleeve in FIG. 2a is equipped with a number of round control windows, the free cross-sectional surface of which is reduced by displacement of the control slide 42. In the illustration chosen in FIG. 2a, the displacement of the control slide 42 is in the direction of the double arrow Δx.

The steering valve 15 forms a hydraulic full bridge, in which four hydraulic single resistors R1 to R4 ware changed in order to adjust a differential pressure between the connections A and B. As a result, different hydraulic pressures are generated in the working chambers 21, 22 of the steering cylinder 19.

The block diagram of the hydraulic full bridge is shown in FIG. 2b. Displacement of the control slide 42 in the control sleeve 41 brings about the mentioned change of the single resistors R1 to R4 due to a change of the free cross-sectional surfaces A₁, A₂, A₃, A₄ of the control windows as caused by the displacement.

The piston 20 in the steering cylinder is acted upon by a differential pressure and exerts a corresponding force on the toothed rod 7, whereby the desired steering aid is produced. Thus, the differential pressure in the steering cylinder 19 can be controlled by the displacement of the control slide 42 of the steering valve 15 that is brought about by the drive comprising servo motor 36 and rotation-translation gear 37. Furthermore, the two pressure sensors 33a, 33b and the central electronic control unit 28 render it possible to adjust the differential pressure to a previously determined nominal value.

The dependency of the differential pressure as a function of the travel covered by the control slide is described by the so-called restrictor equation:

$$Δ {P}_{Bl} = {( \frac{{Q}_{LP} * 0 , 5}{{A}_{Bl} * {n}_{Sb} * {α}_{Bl}} )}^{2} * \frac{{ρ}_{Hyd}}{2}$$

In the equation:
Q_{Lp}: volume flow (volume per time)
A_{Bl}: free cross-sectional surface of the restrictor
n_{Sb}: number of control bores (restrictors)
α_{Bl}: flow figure (that is a defined constant of the restrictor)
ρ_{Hyd}: density of the hydraulic fluid

A constant volume flow is applied in the invention, i.e. Q_{Lp}=const. Exclusively the cross-sectional surface A_{Bl} of the restrictor depends on the displacement travel x.

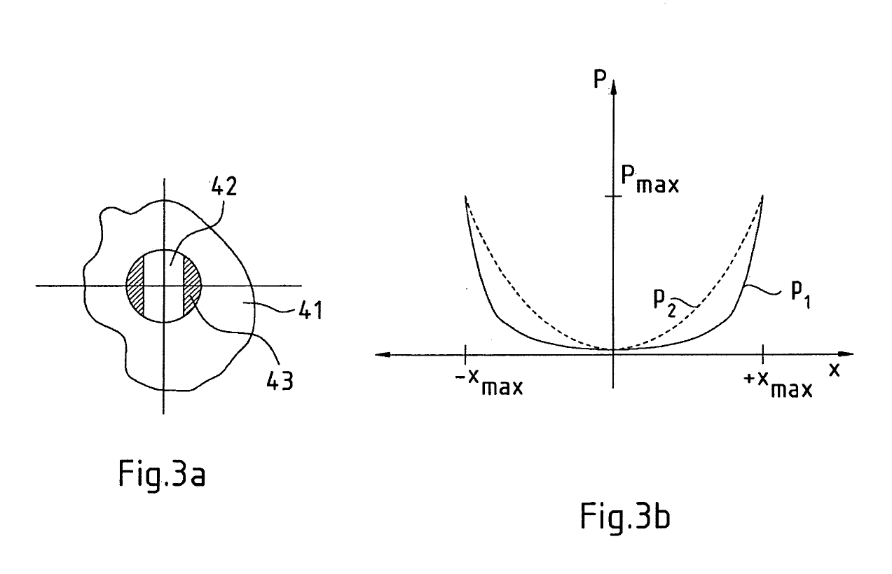

FIG. 3b illustrates the variation of the pressure boosting function in the event of a control window with a circular cross-sectional surface by way of curve p₁. As can be seen, small displacement travels around a neutral position produce only relatively insignificant pressure changes, however, relatively significant pressure changes develop in the end area of the control displacement travel. As the steering aid for the vehicle steering system is dictated by the pressure boosting function, this state of affairs places very high demands on the structure of the pressure controller in order to take the non-linearity described into consideration. It is partly even necessary to limit the dynamics of the control in order to safeguard the stability of the control.

With respect to a simple controller structure and high stability of control, a roughly linear correlation between the generated differential pressure and the control slide travel would be favorable. A corresponding variation of the pressure boosting function is depicted as an example in FIG. 3b by way of curve p₂.

According to the invention, this objective will reach a roughly linear behavior of the pressure boosting function according to the restrictor equation due to a non-linear change of the free cross-sectional surfaces of the control windows in the slide valve. The linear behavior complies with the required dynamics and robustness of the pressure controller.

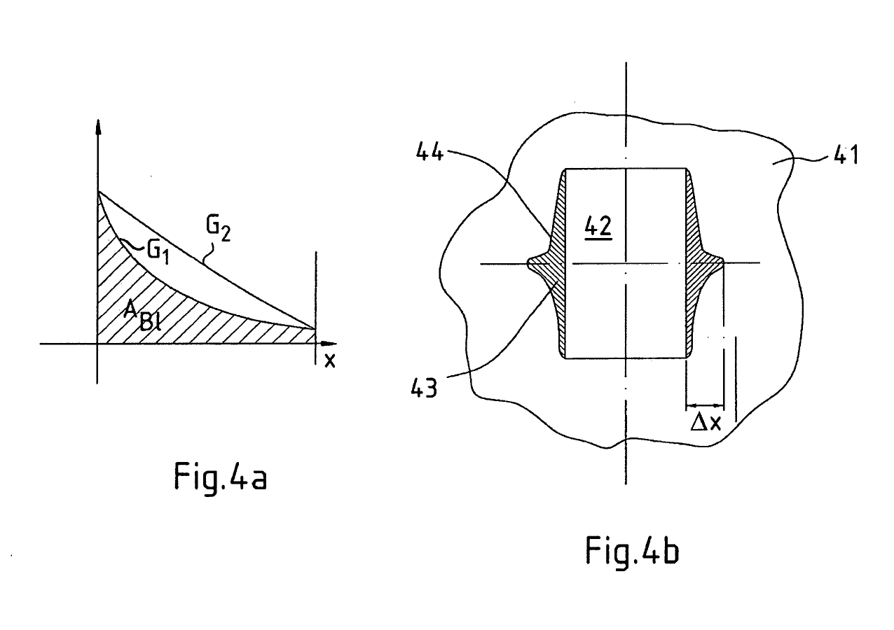

According to the invention, the variation of the change in surface of the aperture is now determined as a function of the control slide travel x. A desired, roughly linear pressure boosting function, as curve p₂ depicts, is predefined for this purpose. The restrictor equation is used to determine from the pressure boosting function the associated surface variation of the free cross-sectional surface A_{Bl}, which is designated as A_{Bl} in FIG. 4a as well as in the restrictor equation. The other quantities of the restrictor equation are presupposed as being known. Since the control slide travel x is known as well, the associated width of a control window 43 can be calculated by differentiation of the surface variation determined hereinabove.

FIG. 4a illustrates the amount of the required non-linear surface variation dA_{Bl}/dx of the free cross-sectional surface of the control windows or the portion of the free cross-sectional surface, which reduces upon displacement of the control slide, by way of the graph G₁ depending on the displacement travel x. The hatched surface under the graph G₁ corresponds to the area of the free cross-sectional surface A_{Bl} of the control window or its mentioned portion. For reasons of comparison, FIG. 4a further depicts by way of the graph G₂ the amount of a surface change which depends linearly on the displacement travel x, as it exists in approximation in the event of a round control window, and which leads to the undesirable non-linear variation of the pressure boosting function.

It is eventually still taken into account in the calculated width of the control window 43 that the control window 43 is disposed in the curved surface of the control sleeve 42, from which follows a shape of contour 44 as shown in FIG. 4b.

In a specific embodiment, the linearized pressure boosting function or the associated surface variation, respectively, is produced with several control windows 43 arranged in parallel. The desired linear behaviour of the pressure boosting function is thus achieved by a corresponding configuration of the shape of contour 44 of the control windows 43.

However, the invention is not restricted to the shape of contour 44 that is illustrated in connection with the embodiment. Rather, the invention also covers any other shape of contour, which allows a linearization of the pressure boosting function.

1.-6. (canceled)

7. A vehicle steering system with a steering handle operable by the driver and connected to steerable vehicle wheels in terms of effect in order to predefine a driving direction, as well as with a hydraulic working cylinder including two cylinder chambers, with a hydraulic pressure source, which applies hydraulic pressure to a steering valve designed as a slide valve, with the steering valve controlling the magnitude of the hydraulic pressure that is conveyed to the cylinder chambers of the working cylinder, and a differential pressure determines the effective direction and the magnitude of the steering aid,
wherein the steering valve is a slide valve and includes a control assembly comprising a control sleeve and a control slide, in that the control sleeve has at least one control window, and the differential pressure in a non-linear relationship depends on the free cross-sectional surface of the control window, which is variable due to displacement of the control slide, and in that the edge of the control window is so configured that the free cross-sectional surface of the control window changes in such a fashion that the magnitude of the differential pressure depends substantially linearly on the displacement of the control slide.

8. The vehicle steering system as claimed in claim 1,
wherein several control windows are provided.

9. The vehicle steering system as claimed in claim 1,
wherein the adjustment of the control slide is a translational displacement.

10. The vehicle steering system as claimed in claim 1,
wherein a drive is provided for the adjustment of the control slide.

11. The vehicle steering system as claimed in claim 4,
wherein the drive is an electromagnetic or an electromotive actuator.

12. The vehicle steering system as claimed in claim 5,
wherein the electromotive actuator is drivingly coupled to a gear, which converts a rotation into a translational movement.
